(19) United States
(12) Patent Application Publication
(10) Pub. No.: US 2024/0295089 A1
(43) Pub. Date: Sep. 5, 2024

(54) WATER CHANNEL

(71) Applicant: Murray Smith, Beaverlodge (CA)

(72) Inventors: Murray Smith, Beaverlodge (CA); Sagar Chaudhary, Calgary (CA)

(21) Appl. No.: 18/590,941

(22) Filed: Feb. 29, 2024

Related U.S. Application Data
(60) Provisional application No. 63/449,753, filed on Mar. 3, 2023.

(51) Int. Cl. E01F 5/00; F03B 17/06

(52) U.S. Cl. CPC E01F 5/005; F03B 17/06

(57) ABSTRACT

A water channel is disclosed. The water channel has a channel body defining a flow passage having an entrance, an exit, and defining a flow direction from the entrance to the exit. Intake deflectors are positioned at the entrance and are angled away from the flow direction relative to the channel body and positioned to direct a flow of water into the entrance of the channel body. Outlet deflectors are positioned at the exit of the channel body and extend away from the exit of the channel body. The outlet deflectors are angled away from the flow direction relative to the channel body.

### TECHNICAL FIELD

This relates to water channels, in particular water channels that increase a flow rate of water.

### BACKGROUND

Man-made water channels are used in various circumstances. One common type of water channel is a culvert, which is used to carry water past an obstacle, such as a roadway, railroad, etc. Typically, culverts are used in conjunction with open drains or ditches, streams, and the like. One example of a culvert can be found in U.S. Pat. No. 10,870,955, entitled “Box Culvert”, which describes a culvert that can be used to carry water past an obstacle.

### SUMMARY

According to an aspect, there is provided a water channel comprising: a channel body defining a flow passage having an entrance, an exit, and defining a flow direction from the entrance to the exit, intake deflectors positioned at the entrance, the intake deflectors being angled away from the flow direction relative to the channel body and positioned to direct a flow of water into the entrance of the channel body, and outlet deflectors positioned at the exit of the channel body and extending away from the exit of the channel body and angled away from the flow direction relative to the channel body.

According to other aspects, the water channel may comprise one or more of the following features, alone or in combination: the water channel may further comprise a turbine positioned within the flow passage such that water flowing through the flow passage drives the turbine; the intake deflectors, the outlet deflectors, or both the intake deflectors and the outlet deflectors may comprise a base deflector at a bottom of the channel body and lateral deflectors on opposed sides of the channel body; the channel body may have a base, a first channel wall, and a second channel wall that extends upward from the base along a first length of the base, the second channel wall being spaced from the second channel wall along a width of the base to define an entrance and an exit, the intake deflectors may be positioned on the first channel wall and the second channel wall adjacent to the entrance, and the outlet deflectors may be positioned on the first channel wall and the second channel walls adjacent to the exit; the first channel wall and the second channel wall may comprise pontoons on opposed sides of the channel body; the angles of the intake deflectors and the outlet deflectors may be adjustable; the intake deflectors and the outlet deflectors may comprise rams that control the angle of the deflectors; wherein the channel body may be a pipe; the channel body may comprise an open top; the water channel may further comprise ballast carried by the channel body, the ballast being adjustable to control a buoyancy of the channel body; the ballast may be adjustable to control a slope of the channel or a depth of the culvert in a body of water; and the water channel may further comprise a plurality of anchors that are adapted to fix the channel body in a desired position.

According to an aspect, there is provided a method of driving a turbine, the method comprising the steps of: positioning a water channel in a body of water, the water passage comprising a channel body defining a flow passage, the channel body having an entrance, an exit, and defining a flow direction from the entrance to the exit, intake deflectors positioned at the entrance, the intake deflectors being angled away from the flow direction relative to the channel body and positioned to direct a flow of water into the entrance of the channel body, and outlet deflectors positioned at the exit of the pipe and extending away from the exit of the channel body and angled away from the flow direction relative to the channel body, and a liquid-driven turbine disposed within the flow passage; permitting water to flow through the flow passage along the flow direction and drive the liquid-driven turbine; and adjusting the water channel to control the flow of water through the flow passage.

According to other aspects, the method may comprise one or more of the following features, alone or in combination: adjusting the water channel may comprise setting a depth, an orientation of the water channel relative to a surface of the body of water, or both a depth and an orientation of the water channel in the body of water; adjusting the water channel may comprise controlling a ballast carried by the water channel; the method may further comprise a step of adjusting an angle of the intake deflectors, the outlet deflectors, or both the intake deflectors and the outlet deflectors; the method may further comprise a step of installing the channel body below a top surface of an obstacle such that the flow passage traverses the obstacle; the method may further comprise a step of anchoring the channel body at a desired position in a body of water; and the method may further comprise a step of adjusting the intake deflectors, the outlet deflectors, or both the intake deflectors and the outlet deflectors to increase a flow velocity of the flow of water through the channel body.

In other aspects, the features described above may be combined together in any reasonable combination as will be recognized by those skilled in the art.

### BRIEF DESCRIPTION OF DRAWINGS

These and other features will become more apparent from the following description in which reference is made to the appended drawings, the drawings are for the purposes of illustration only and are not intended to be in any way limiting, wherein:

FIG. 1 is a top plan view of a water channel passing under a road.

FIG. 2 is a top plan view of a water channel located in a liquid flow stream.

FIG. 3 is a top plan view of a water channel with a movable ballast.

FIG. 4 is an elevated side, cross-section view of the water channel of FIG. 2.

FIG. 5 is an elevated side, cross-section view of the water channel of FIG. 3.

FIG. 6 is an elevated end view of the water channel of FIG. 2.

FIG. 7 is an elevated end view of the water channel of FIG. 3.

### DETAILED DESCRIPTION OF PREFERRED EMBODIMENTS

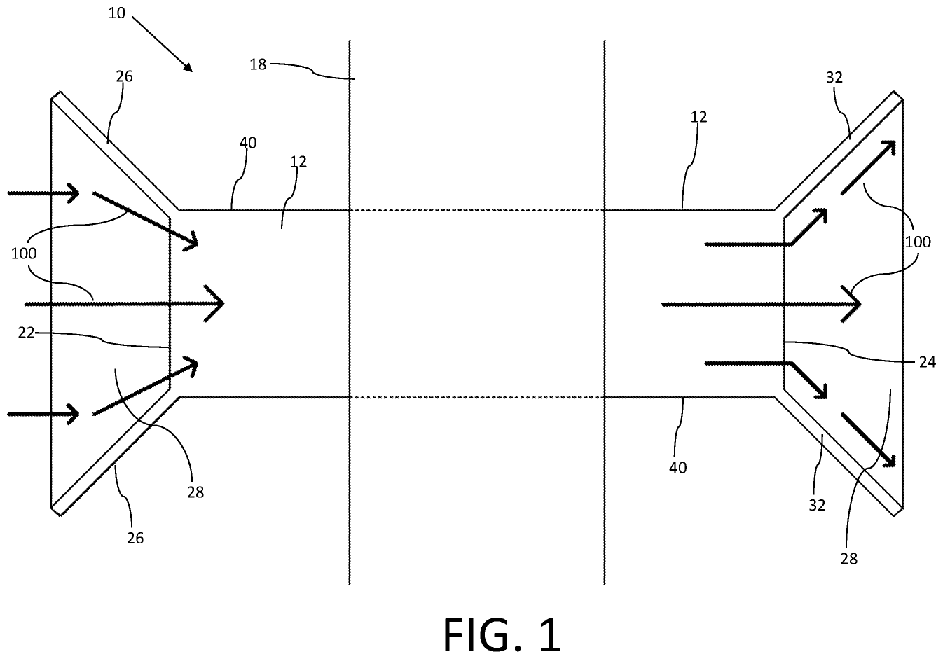

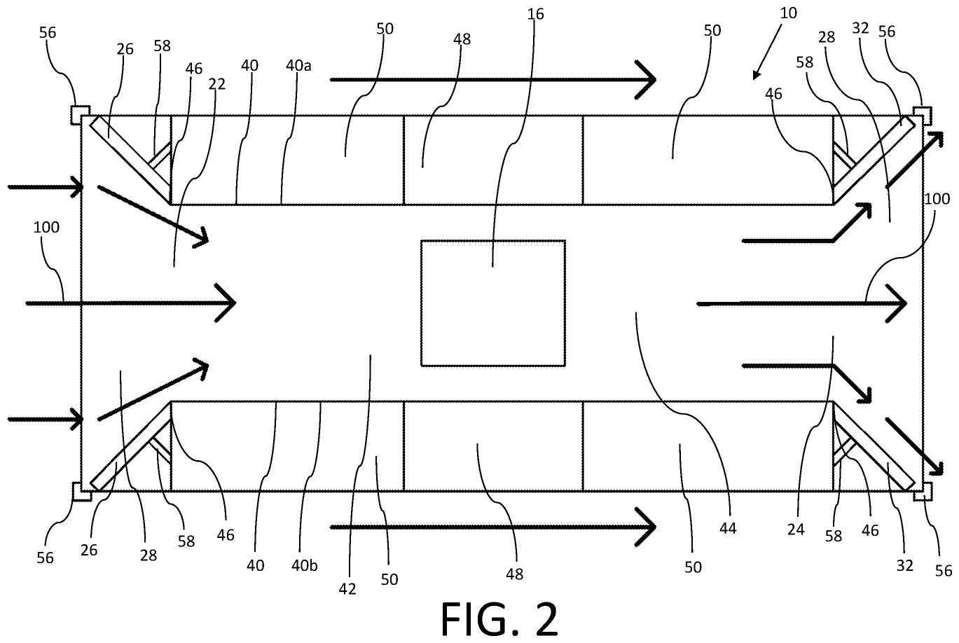

A water channel, generally identified by reference numeral 10, will now be described with reference to FIG. 1 through 7. Water channel 10 is used to control and accelerate a flow of water 100. Examples of water channels 10 that will be discussed may include different forms of a channel body, such as culvert 12, which will be described with reference to FIG. 1, and a water channel 10 for a water-powered turbine 16, which will be discussed with reference to FIG. 2 through 7.

Referring to FIG. 1, culvert 12 may be installed as a permanent pathway for flow of water 100, such as a stream or open ditch, to traverse an obstacle, such as a roadway 18 as shown.

Culvert 12 has an entrance 22 and an exit 24 and defines a flow direction for a flow of water 100. Culvert 12 may have a square or rectangular cross-section, or a circular or oval cross-section, or other suitable cross-section, and may be a pipe. Culvert 12 may be closed on all sides between entrance 22 and exit 24. Culvert 12 may have intake deflectors 26 that are vertically oriented and positioned on either side of entrance 22 of culvert 12 at an angle to direct flow of water 100 into pipe entrance 22. Intake deflectors 26 may be connected to culvert 12 immediately adjected to entrance 22, and oriented such that they extend away from entrance 22 at an angle. Intake deflectors 26 may also include a base deflector 28 that extends outward from a bottom surface of culvert 12 and between intake deflectors 26. Intake deflectors 26 and base 28 may cause a flow velocity of flow of water 100 to increase as the flow of water 100 enters culvert 12. Intake deflectors 26 may be planar or contoured, such as curved. Intake deflectors 26 may be on a box or rectangular pipe located at entrance 22 to direct water into pipe 20.

It has been found that the angle of intake deflectors 26 may vary the velocity of the liquid passing through channel body 12. In some cases, it may be possible to increase the velocity of the liquid passing through culvert 12 significantly, such as up to approximately 1.5 times the velocity of the stream. Intake deflectors 26 may be positioning to increase flow velocity at an angle of about 45 degrees. The angle may be more or less than this, such as between 35-55 degrees. By adjusting intake deflectors 26, the flow velocity may be accelerated or slowed to achieve a desired result. In some cases, a desired flow velocity may be less than the optimal, or highest possible velocity, in which case different angles may be used, including angles outside this range. The specific angle to achieve a desired result may be determined based on observational data based on a given implementation. Depending on the implementation, the highest possible velocity may be outside the range discussed above.

In addition to the angle, the length of intake deflectors 26 may also have an impact on the flow velocity through channel body 12, insofar as it relates to the flow area at the beginning of intake deflectors 26 relative to the flow area of channel body 12, i.e. the flow area that is downstream of intake deflectors 26, and upstream of outlet deflectors 32. It will be understood that the flow area will be affected by the length of intake deflectors 26 and the angle. It has been found that a flow area of about 60% greater than the flow area of channel body 12 may be used to increase the flow velocity. The flow area may be more or less than this, such as between 50% to 70%. In some cases, a desired flow velocity may be less than the highest possible velocity, in which case different angles may be used, including angles outside this range. The specific flow area that achieves a desired result may be determined based on observational data and may be based on a given implementation. Depending on the implementation, the highest possible velocity may be outside the range discussed above. The flow area may be adjusted by adjusting the angle or length of intake deflectors 26. The length of intake deflectors 26 may be designed based on a particular angle or range of angles that is expected to be used during operation.

Outlet deflectors 32 are laterally positioned deflectors that allow the flow area of flow of water 100 to expand as the flow exits culvert 12. Outlet deflectors 32 may be connected to culvert 12 immediately adjected to exit 24, and oriented such that they extend away from exit 24 at an angle, such as about 45 degrees

It has been found that the angle of outlet deflectors 32 may be controlled or specified to affect the flow velocity through channel body 12. For example, an angle of about 45%, or within a range of between 35-55 degrees, may be used to affect the flow velocity through channel body 12. It has also been found that the length of outlet deflectors 32 may also be controlled or specified to affect the flow velocity. Assuming a suitable angle of outlet deflectors 32, a longer length of outlet deflectors 32 may increase the flow velocity through channel body 12, with the impact decreasing as the length increases beyond a certain point. It is believed that, assuming deflectors 32 are at a suitable angle, a length that corresponds to a flow area that is about 60% larger than the flow area of the channel body 12, or about 50% larger, may provide beneficial results. Different lengths may also be used to provide a desired flow velocity.

Outlet deflectors 32 may also include a base deflector 28 that extends outward from the bottom of culvert 12 and between outlet deflectors 32. It has been found that the proper design and use of outlet deflectors 32 may increase the velocity of the liquid passing through culvert 12, such as up to approximately 2 times the velocity of the stream. Where intake deflectors 26 are also used that increase the flow rate up to about 1.5 times, the velocity of flow of water 100 in culvert 12 may be increased up to about three times the velocity of flow of water 100 upstream of culvert 12. Outlet deflectors 32 may be planar or contoured.

Intake deflectors 26 and/or outlet deflectors 32, as the case may be, may be mounted adjacent to entrance 22 such that the water-facing surface of deflectors 26 and 32 intersect with the water-facing surface of sidewalls 40 to provide a continuous flow path for water being directed into and out of flow channel 20. Further, while deflectors 26 and 32 are described separately from channel body 12, it will be understood that may be integrally formed with channel body 12, may be securely or fixedly attached as a separate element. Intake deflectors 26 and/or outlet deflectors 32 may be attached or formed to be moveable with respect to channel body, 12 such as by a hinge or living hinge, in order to adjust the relative angle.

Culvert 12 may be used to reduce pressure at exit 24 of the culvert and reduce downstream fluid velocity, which may help prevent erosion. Alternatively or in addition, culvert 12 may be used accelerate the fluid flow rate substantially as it passes through culvert 12, and then use the outlet deflectors 32 to help return the fluid flow to normal stream flow more quickly than would otherwise be the case.

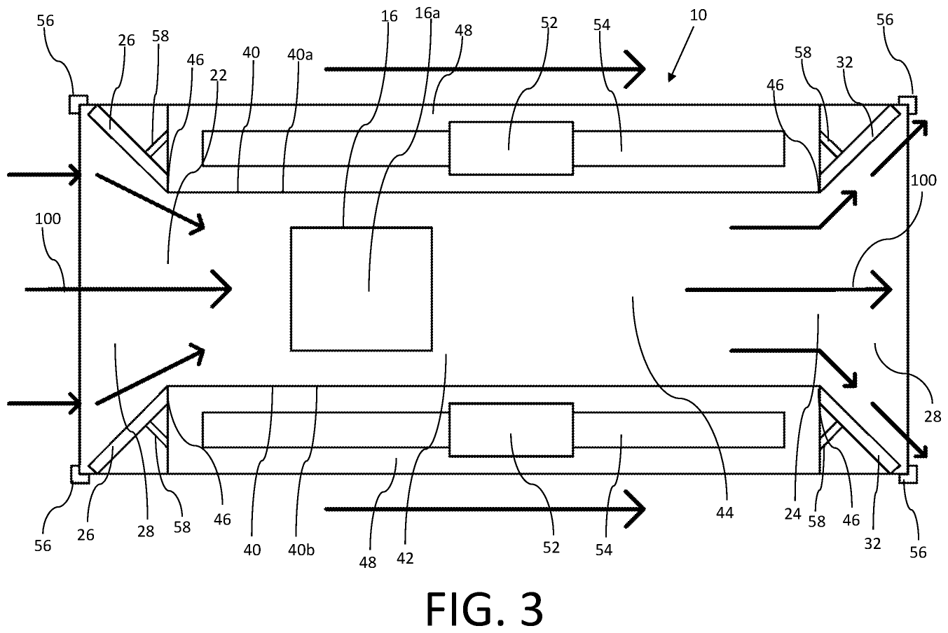

Referring to FIG. 2 and FIG. 3, a liquid-driven turbine 16 may be installed in water channel 10. Turbine 16 may include fluid-drive components, such as rotors that rotates about a vertical, horizontal, or angled axis. In the depicted example, turbine 16 may have with turbine blades, where a block 16a is an example of where the turbine blades may be positioned. Channel body 12 may have sidewalls 40 and a base 42 that extend along a length of water channel 10 to define a flow passage 44 with entrance 22 and an exit 24. Sidewalls 40 and base 42 may have substantially flat surfaces. Intake deflectors 26 and outlet deflectors 32 as described above direct flow of water 100 into and out of flow passage 44. Base 42 may extend outward from entrance 22 or exit 24 to define base deflectors 28. As shown, base deflectors 28 may be part of the substantially flat surface of base 42 and may extend parallel to base 42. Base deflectors 28 may also extend away from entrance 22 and exit 24 at an angle, which may be adjustable.

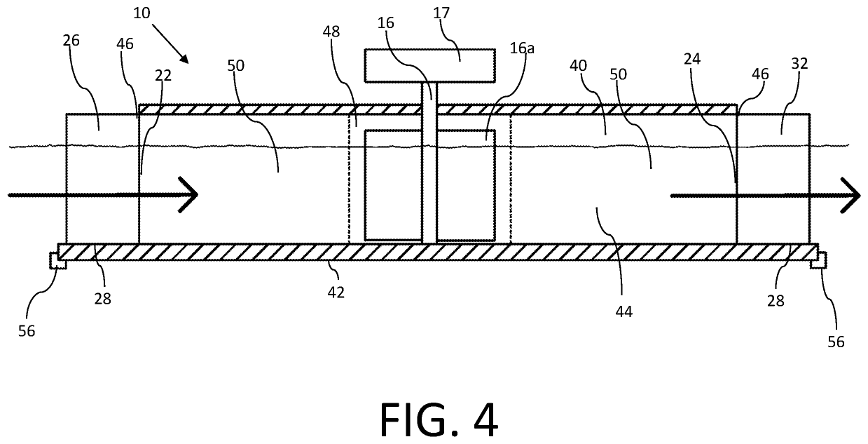

While water channel 10 has been described as a culvert, water channel 10 may also be installed in a body of water that has a current, and may be partially or fully submerged. Water channel 10 may have an open top when not used as a culvert. Referring to FIG. 3 and FIG. 4, water channel is shown partially submerged in a body of water such that a water level 102 is within flow passage 44. When submerged, flow of water 100 enters water channel 10, and water channel 10 causes the velocity of the flow of water to increase within flow passage 44. This may be particularly useful when turbine 16 is positioned within flow passage 44 such that turbine 16 is driven by flow of water 100 to drive a generator 17.

Intake deflectors 26 and outlet deflectors 32 may be adjustable. This may be less practical on permanent installations such as with culverts 12 and may be beneficial for use in controlling the flow rate when used with water-powered turbines 16. As shown, intake deflectors 26 and outlet deflectors 32 may be attached to sidewalls 40 at an axle 46 adjacent to entrance 22 of flow passage 44. Intake deflectors 26 and outlet deflectors 32 may be adjustable such that they pivot around axle 46 to control the angle at which intake deflectors 26 and outlet deflectors 32 are positioned. The angle of intake deflectors 26 and outlet deflectors 32 may be adjusted by rams 58. The angle of intake deflectors 26 and outlet deflectors 32 may be set to control a velocity of flow of water 100 within flow passage 44 or the behaviour of flow of water 100 after it exits water channel, which may allow a user to keep the current more consistent, or to increase or decrease the current as required.

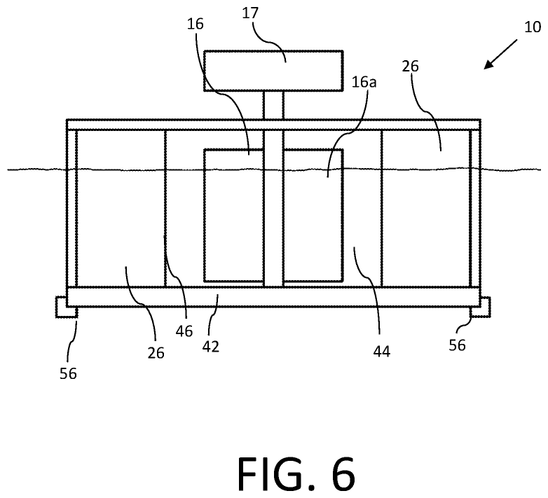

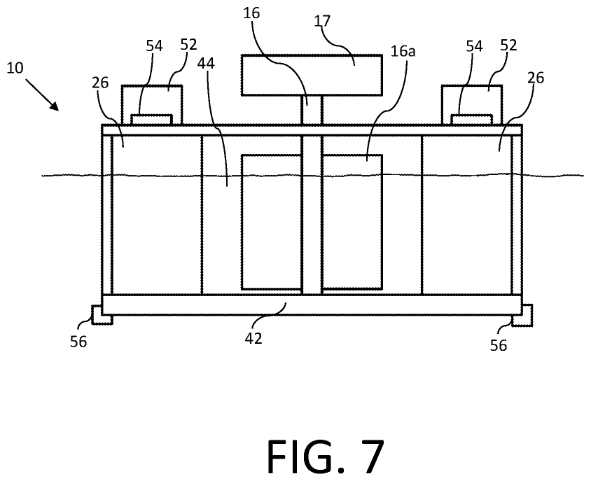

Referring to FIG. 6 and FIG. 7, water channel 10 may have first and second sidewalls 40a and 40b made from pontoons 48 that are carried by base 42. Pontoons 48 may extend parallel to one another and have an internal volume. Pontoons 48 may house components of water channel 10 that need to be isolated from flow of water 100 in passage 44 or from the body of water that water channel 10 is submerged in.

Referring to FIG. 2, FIG. 4, and FIG. 6, water channel 10 may have one or more ballast tanks 50 with a fixed or adjustable weight, such as by using a pump to control the volume of water in ballast tanks 50. Ballast tanks 50 may be filled with water to control a depth and orientation of the water channel 10 and passage 44 when installed in a body of water. Water passage 10 may have multiple ballast tanks 50 in order to balance the weight of the ballast when it is filled. The ballast may be adjustable along the length or width of the water passage to adjust the center of gravity. Ballast tanks 50 may be adjustable by providing partitioned sections that may be adjusted individually. Ballast 50 may be used in conjunction with pontoons 48 to control the buoyancy and/or weight distribution of water channel 10. For example, the buoyancy of pontoons 48 may be adjusted by controlling the internal volume of air. Ballast 50 may be located within pontoons 48.

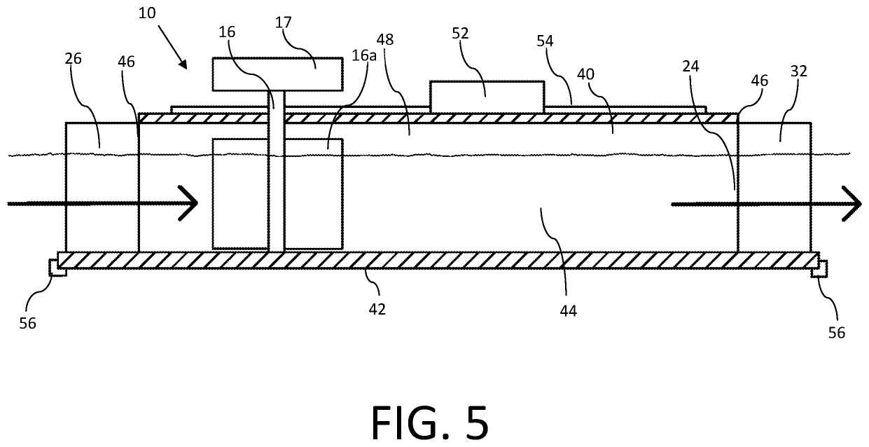

Referring to FIG. 3, FIG. 5 and FIG. 7, water channel 10 may have one or more solid, movable ballast weight 52 that can be selectively positioned relative to pontoons 48 to adjust an orientation of water passage when submerged. Movable ballast weights may be mounted on a track 54 along which it is movable. Water channel 10 may have movable ballast weights 52 instead of ballast tanks 50 or in addition to ballast tanks 50. The position of pontoons 48 may be adjustable in addition to or instead of the position of ballast 50, which may also be used to adjust water channel 10 as discussed above.

Water channel 10 may have anchor points 56 that are used hold water channel 10 in a location within a body of water. Anchor points 56 may be located at the corners of base 42, such that anchor points 56 are located on either side of the channel to ensure water channel can be balanced when connected to anchors. The use of least two anchor points 56 is preferable to stabilize the water passage when submerged in the body of water. Anchor points 56 may be particularly useful where water channel 10 is installed in a body of water with a current.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context requires that there be one and only one of the elements.

The scope of the following claims should not be limited by the preferred embodiments set forth in the examples above and in the drawings but should be given the broadest interpretation consistent with the description as a whole.

What is claimed is:

1. A water channel comprising:
a channel body defining a flow passage having an entrance, an exit, and defining a flow direction from the entrance to the exit;
intake deflectors positioned at the entrance, the intake deflectors being angled away from the flow direction relative to the channel body and positioned to direct a flow of water into the entrance of the channel body; and
outlet deflectors positioned at the exit of the channel body and extending away from the exit of the channel body and angled away from the flow direction relative to the channel body.

2. The water channel of claim 1, further comprising a turbine positioned within the flow passage such that water flowing through the flow passage drives the turbine.

3. The water channel of claim 1, wherein the intake deflectors, the outlet deflectors, or both the intake deflectors and the outlet deflectors comprise a base deflector at a bottom of the channel body and lateral deflectors on opposed sides of the channel body.

4. The water channel of claim 1, wherein:
the channel body has a base, a first channel wall, and a second channel wall that extends upward from the base along a first length of the base, the second channel wall being spaced from the second channel wall along a width of the base to define an entrance and an exit;
the intake deflectors are positioned on the first channel wall and the second channel wall adjacent to the entrance; and
the outlet deflectors are positioned on the first channel wall and the second channel walls adjacent to the exit.

5. The water channel of claim 4, wherein the first channel wall and the second channel wall comprise pontoons on opposed sides of the channel body.

6. The water channel of claim 1, wherein the angles of the intake deflectors and the outlet deflectors are adjustable.

7. The water channel of claim 6, wherein the intake deflectors and the outlet deflectors comprise rams that control the angle of the deflectors.

8. The water channel of claim 1, wherein the intake deflectors are at an angle of between 35 and 55 degrees, and define a flow area of between 40% and 70% larger than a flow area of the flow passage at a point between the inlet deflectors and the outlet deflectors.

9. The water channel of claim 1, wherein the outlet deflectors are at an angle of between 35 and 55 degrees and define a flow area of at least 40% larger than a flow area of the flow passage at a point between the inlet deflectors and the outlet deflectors.

10. The water channel of claim 1, wherein the channel body is a pipe or has an open top.

11. The water channel of claim 1, further comprising ballast carried by the channel body, the ballast being adjustable to control a buoyancy of the channel body.

12. The water channel of claim 10, wherein the ballast is adjustable to control a slope of the channel or a depth of the culvert in a body of water.

13. The water channel of claim 1, further comprising a plurality of anchors that are adapted to fix the channel body in a desired position.

14. A method of driving a turbine, the method comprising the steps of:
positioning a water channel in a body of water, the water passage comprising:
a channel body defining a flow passage, the channel body having an entrance, an exit, and defining a flow direction from the entrance to the exit;
intake deflectors positioned at the entrance, the intake deflectors being angled away from the flow direction relative to the channel body and positioned to direct a flow of water into the entrance of the channel body;
outlet deflectors positioned at the exit of the pipe and extending away from the exit of the channel body and angled away from the flow direction relative to the channel body; and
a liquid-driven turbine disposed within the flow passage;
permitting water to flow through the flow passage along the flow direction and drive the liquid-driven turbine; and
adjusting the water channel to control the flow of water through the flow passage.

15. The method of claim 13, wherein adjusting the water channel comprises setting a depth, an orientation of the water channel relative to a surface of the body of water, or both a depth and an orientation of the water channel in the body of water.

16. The method of claim 13, wherein adjusting the water channel comprises controlling a ballast carried by the water channel.

17. The method of claim 13, further comprising a step of adjusting an angle of the intake deflectors, the outlet deflectors, or both the intake deflectors and the outlet deflectors.

18. The method of claim 13, further comprising a step of installing the channel body below a top surface of an obstacle such that the flow passage traverses the obstacle.

19. The method of claim 13, further comprising a step of anchoring the channel body at a desired position in a body of water.

20. The method of claim 13, further comprising a step of adjusting the intake deflectors, the outlet deflectors, or both the intake deflectors and the outlet deflectors to increase a flow velocity of the flow of water through the channel body.
